(19) United States
(12) Patent Application Publication
(10) Pub. No.: US 2012/0058708 A1
(43) Pub. Date: Mar. 8, 2012

(54) Backpack bee vacuum

(76) Inventor: John Henry Nenninger, Festus, MO (US)

(21) Appl. No.: 12/807,387

(22) Filed: Sep. 3, 2010

(51) Int. Cl. A01K 57/00

(52) U.S. Cl. 449/61

(57) ABSTRACT

A single unit device carried as a backpack used to capture and transfer bees. This single unit device is operated with an attached vacuum device and a removable inner screen containment cage. The device increases the capture capabilities of the user. Because the unit is strapped to the operator, this enhances the operator's ability to reach swarms that are currently beyond the reach of present day's equipment. The backpack always allows the operator to have one hand on the vacuum nozzle and the other hand free during operation. The unit can be operated on normal electrical current or a battery. When the unit is operated on a battery this gives the user the greatest flexibility to capture bees in hard to reach and/or remote locations.

### CROSS-REFERENCE TO RELATED APPLICATIONS

### US Patent Documents

U.S. Pat. No. 4,288,880 Sep. 15, 1991 Norman E. Gary: Kenneth Lorenzen

U.S. Pat. No. 6,702,645 B2 Mar. 9, 2004 Harry E. Vanderpool

U.S. Pat. No. 2,829,384 Apr. 8, 1958 A. A. Studler

### Publication Number(s)

US 2009/0068926 A1 Mar. 12, 2009 Joseph M. Venglar

### STATEMENT REGARDING FEDERALLY SPONSORED

“Not Applicable”

### BACKGROUND OF THE INVENTION

Device identified as, “Assembly for Capturing Bees,” with the publication number US 2009/0068926 A1 is composed of two separate entities. One entity is a vacuum canister. A vacuum hose connects the canister to the second entity, the “box.” The box is made up of two components: the collection chamber and a hive box. The box has frames of wax foundations which limit the number of swarms that can be captured and contained separately. There is a second vacuum hose attached to the box entity that is used to vacuum the captured bees into the collection chamber. This design requires a platform(s) to elevate and hold these two separate units (the box and the canister) in place as the operator manipulates the vacuum hose. This design limits the operator to capturing swarms that are well within the reach of the operator's height. The vacuum design forces the bees to be congested along the surface area of the collection chamber. This congestion of pressuring the bees could add stress and increase the death rate of the captured bees. When the vacuum pressure is released, the bees fall or concentrate down into frames within the hive box. My design overcomes the limitations of having to carry a box and a vacuum suction device separately. The box design is made of two separate components (the collection chamber and the hive) that can and will separate during transport. My design eliminates this flaw by having the bees contained in a single unit with a removable screen containment cage.

Device identified as, “Separating Parasites from Bees,” U.S. Pat. No. 6,702,645 B2 is a device to dust bees to dislodge the Varroa mite parasite. Its intent is not to capture swarms of bees and relocate them to a permanent beehive. This device is only mobile through the use of pneumatic tires that limit its usefulness to stationary and accessible beehives located at ground level.

Device identified as, “Bee Vacuum Device and Method of Handling Bees,” U.S. Pat. No. 4,288,880, is a device to remove bees from frames of comb honey. Its intent is not to capture swarms of bees. The device further separates the bees into three categories, queen, drone, and worker. This is a stationary unit used in a facility which harvests honey.

Device identified as, “Bee Swarm Collector,” U.S. Pat. No. 2,829,384 is a handheld device with a stationary nozzle that limits the accessibility to collect bees in easy to reach locations. It requires two hands to operate by holding the entire unit while vacuuming the bees. The unit does not permit multiple captures of different swarms of bees because the bees are actually captured into the vacuum device which does not include a removable containment unit.

### BRIEF SUMMARY OF THE INVENTION

The Backpack Bee Vacuum invention is used to capture insects, specifically bees, without limitations such as the height of the swarm or swarms, distance from a reliable electrical source, along with minimizing injury or death of the insects or bees. This invention is only limited by the ability of the operator.

### BRIEF DESCRIPTION OF THE DRAWING

FIG. 1 is a pictorial view showing the back and right side of the Backpack Bee Vacuum single unit device. The vacuum component is attached to the back of the bee capture box. This view includes the vacuum input hose, extension cord, and a pressure regulator valve located at the bottom of the box.

FIG. 2 is a pictorial view showing the front of the Backpack Bee Vacuum single unit bee capture box. It shows the two shoulder straps, and the one belt strap. Attached to the front of the box is foam padding. The top is latched by the use of two latches. The extension cord is shown along with the vacuum suction hose.

FIG. 3 is a cutaway view showing the inner screen containment cage located inside the outer unit of the Backpack Bee Vacuum capture box. The suction hose and a pressure regulator are shown on the left hand side. The vacuum component suction outlet is shown in the middle of the diagram.

FIG. 4 is a pictorial view of the inner screen containment cage. The inlet hole that aligns with the vacuum suction hose has a sliding device that prevents the bees from escaping. The top of the screen containment cage can be opened to facilitate removal of the bees into a beehive. There are four blocks on the bottom of the containment cage to allow airflow to all other sides of the containment cage.

FIG. 5 is a pictorial view of the inner removable screen containment cage. The containment cage is fabricated of screen on all sides except the top and one side (where the vacuum hose is connected to the screen containment cage).

### DETAILED DESCRIPTION OF THE INVENTION

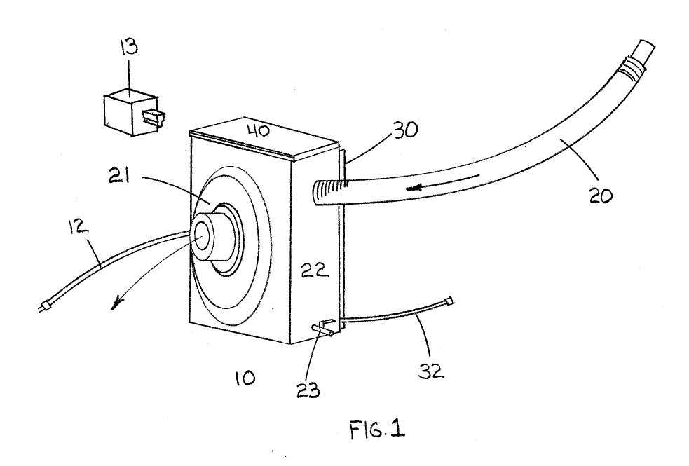

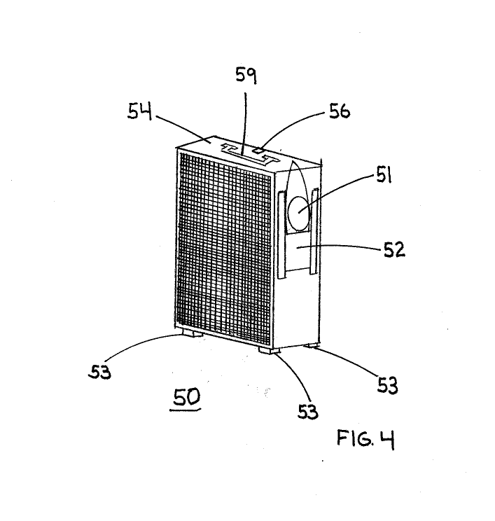

FIG. 1 shows the two basic components of the Backpack Bee Vacuum self-contained single unit 10. The containment box 22, which has a detachable vacuum hose 20 used to vacuum the bees from the source into the removable containment screen cage FIG. 4, 50. To help regulate the amount of suction pressure, a pressure regulated valve 23 is located near the bottom of the containment box 22. The vacuum component 21 is attached and centered on the back of the containment box 22 which operates on normal electrical current using the attached cord 12 or a battery 13.

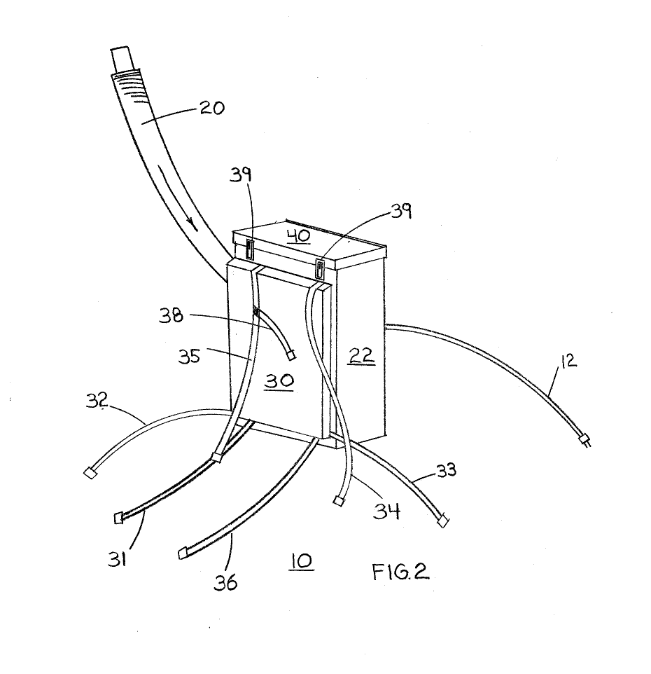

FIG. 2 shows the harnessing system 35, 34, 31, 32, 33, 38, and 36 used in this Backpack Bee Vacuum self-contained single unit 10 which makes this unit a very mobile device. There are three sets of strapping used to secure this Backpack Bee Vacuum self-contained single unit 10 to the back of the operator. A set of straps 35 and 31 are snapped together to secure the unit to the right shoulder. A second set of straps 34 and 36 are snapped together over the left shoulder. A third set of straps 32 and 33 are snapped together around the waist. To help secure the unit snug to the back of the operator a small strap 38 is attached between the two shoulder straps 35 and 34. There is a padding 30 that forms to the back of the operator and helps to eliminate discomfort. Two latches 39 are used to securely close the hinged top 40 during operation or transport. The hinged top 40 gives the user access to the removable containment screen cage FIG. 4, 50.

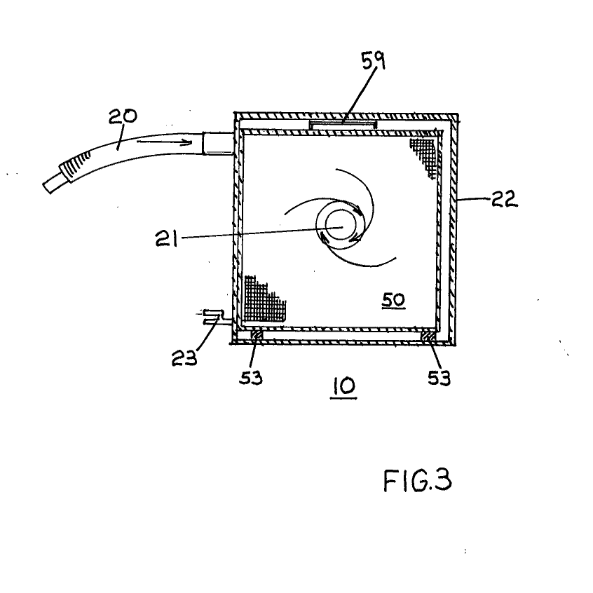

FIG. 3 shows a cutaway view of the Backpack Bee Vacuum self-contained single unit 10, the containment box 22 and the removable containment screen cage 50. The removable containment screen cage 50 is placed within the containment box 22 in such a way that permits airflow around the entire containment screen cage 50. The bees are sucked in through the vacuum hose 20 through the containment box 22 into the removable containment screen cage 50. The suction of the vacuum component FIG. 1, 21 is centered on the back of the containment box 22 allowing for an even airflow throughout the removable containment screen cage 50. The pressure regulator valve 23 assists in the amount of suction through the vacuum hose 20 that is required to capture and contain the bees in the removable containment screen cage 50.

FIG. 4 shows the removable containment screen cage 50 with the access 51 for the vacuum hose FIG. 1, 20 and a sliding door 52 used to prevent the captured bees from escaping during transport. The hinged top 54 is held in place by a latch 56. A handle 59 on top of the hinged top 54 is used to lift the removable containment screen cage 50 into and out of the containment unit 22. The handle 59 is also used to carry the removable containment screen cage 50. Four one inch blocks 53 are attached to facilitate airflow around the bottom of the removable containment screen cage 50.

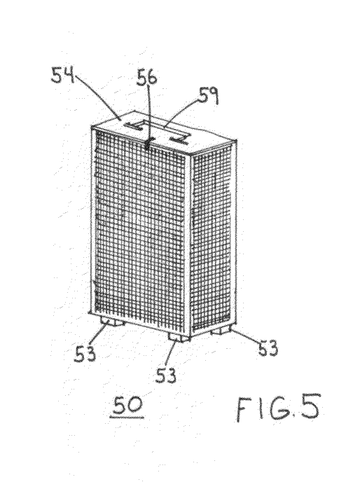

FIG. 5 shows the removable containment screen cage 50 with the four one inch block spacers 53, the hinged top 54 with the latch 56 and handle 59, and the screened sides. The hinged top 54 facilitates the transfer of the captured bees to an appropriate container to keep bees.

1. The engineering design of my Backpack Bee Vacuum single unit device supersedes all present day devices used to capture insects or bees. My device is a single unit device made up of the vacuum and capture components worn as a single “back pack.” This eliminates the need for platform(s) to hand hold multiple component devices that are currently used today.

2. The engineering design of my Backpack Bee Vacuum single unit device does not require the operator to hold the unit with one hand and operate the vacuum hose with the other. My Backpack Bee Vacuum permits the operator to access any areas and limited only by the height of the ladder or high lift in conjunction with the ability of the operator.

3. The engineering design of my Backpack Bee Vacuum single unit device with its internal movable screen cage permits the operator the ability to capture multiple swarms by switching out individual screen containment cages as needed, keep the swarms separated and transportable to separate permanent locations.

4. The engineering design of my Backpack Bee Vacuum single unit device internal removable screen cage permits air flow throughout the entire surface area of the removable screen cage. This prevents clogging and congestion of bees.
